(19) United States
(12) Patent Application Publication
(10) Pub. No.: US 2021/0109795 A1
(43) Pub. Date: Apr. 15, 2021

(54) Latency-Aware Thread Scheduling

(71) Applicant: Microsoft Technology Licensing, LLC, Redmond, WA (US)

(72) Inventors: Gregory John COLOMBO, Kirkland, WA (US); Rahul NAIR, Bellevue, WA (US); Mark Allan BELLON, Seattle, WA (US); Christopher Peter KLEYNHANS, Bothell, WA (US); Jason LIN, Bellevue, WA (US); Ojasvi CHOUDHARY, Seattle, WA (US); Tristan Anthony BROWN, Seattle, WA (US)

(73) Assignee: Microsoft Technology Licensing, LLC, Redmond, WA (US)

(21) Appl. No.: 16/599,195

(22) Filed: Oct. 11, 2019

(51) Int. Cl. G06F 9/50; G06F 9/48

(52) U.S. Cl. CPC G06F 9/5044; G06F 2209/5021; G06F 9/48

(57) ABSTRACT

Described herein is a system and method for latency-aware thread scheduled. For each processor core, an estimated cost to schedule a particular thread on the processor core is calculated. The estimated cost to schedule can be a period of time between the scheduling decision and the point in time where the scheduled thread begins to run. For each processor core, an estimated cost to execute the particular thread on the processor core is calculated. The estimated cost to execute can be a period of time spent actually running the particular thread on a particular processor core. A determination as to which processor core to utilize for execution of the particular thread based, at least in part, upon the calculated estimated costs to schedule the particular thread and/or the calculated estimated costs to execute the particular thread. The particular thread can be scheduled to execute on the determined processor core.

### BACKGROUND

Modern computers can contain multiple processor and each processor can include one or more processor cores. Application(s) are executed by an operating system run in the context of a process. Although processes contain the program modules, context and environment, processes are not directly scheduled to run on a processor. Instead, thread(s) that are owned by a process are scheduled to run on a processor. A thread maintains execution context information with computation managed as part of the thread. Thread activity thus fundamentally affects measurements and system performance.

### SUMMARY

Described herein is a system for latency-aware thread scheduling, comprising: a computer comprising a processor and a memory having computer-executable instructions stored thereupon which, when executed by the processor, cause the computer to: receive a request to schedule execution of a particular thread; for each of a plurality of processor cores, calculate an estimated cost to schedule the particular thread on the processor core; for each of the plurality of processor cores, calculate an estimated cost to execute the particular thread on the processor core; determine which processor core of the plurality of processor cores to utilize for execution of the particular thread based, at least in part, upon the calculated estimated costs to schedule the particular thread and the calculated estimated costs to execute the particular thread; and schedule the particular thread to execute on the determined processor core.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for latency-aware thread scheduling.

FIG. 2 is a flow chart that illustrates a method of latency-aware thread scheduling.

FIG. 3 is a flow chart that illustrates a method of using latency associated with scheduling to schedule a thread.

FIG. 4 is a flow chart that illustrates a method of using latency associated with executing to schedule a thread.

FIG. 5 is a functional block diagram that illustrates an exemplary computing system.

### DETAILED DESCRIPTION

Various technologies pertaining to latency-aware thread scheduling are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding latency-aware thread scheduling. What follows are one or more exemplary systems and methods.

Aspects of the subject disclosure pertain to the technical problem of thread scheduling. The technical features associated with addressing this problem involve receiving a request to schedule execution of a particular thread; for each of a plurality of processor cores, calculating an estimated cost to schedule the particular thread on the processor core; for each of the plurality of processor cores, calculating an estimated cost to execute the particular thread on the processor core; determining which processor core of the plurality of processor cores to utilize for execution of the particular thread based, at least in part, upon the calculated estimated costs to schedule the particular thread and the calculated estimated costs to execute the particular thread; and scheduling the particular thread to execute on the determined processor core. Accordingly, aspects of these technical features exhibit technical effects of more efficiently and effectively scheduling threads of a multi-threaded, multi-processor core environment, for example, increasing the throughput of the system while reducing the wait time and/or overhead.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

Described herein are a system and method for latency-aware thread scheduling. In response to receiving a request to schedule execution of a particular thread, estimated costs (e.g., latencies) to schedule the particular thread can be calculated for each of a plurality of processor cores. Estimated costs to execute the particular thread on each of the plurality of processor cores can also be calculated. A particular processor core of the plurality of processor cores to utilize for execution of the particular thread can be determined (e.g., selected) based, at least in part, upon the calculated estimated costs to schedule the particular thread and the calculated estimated costs to execute the particular thread. The particular thread can be then be scheduled to execute on the determined processor core.

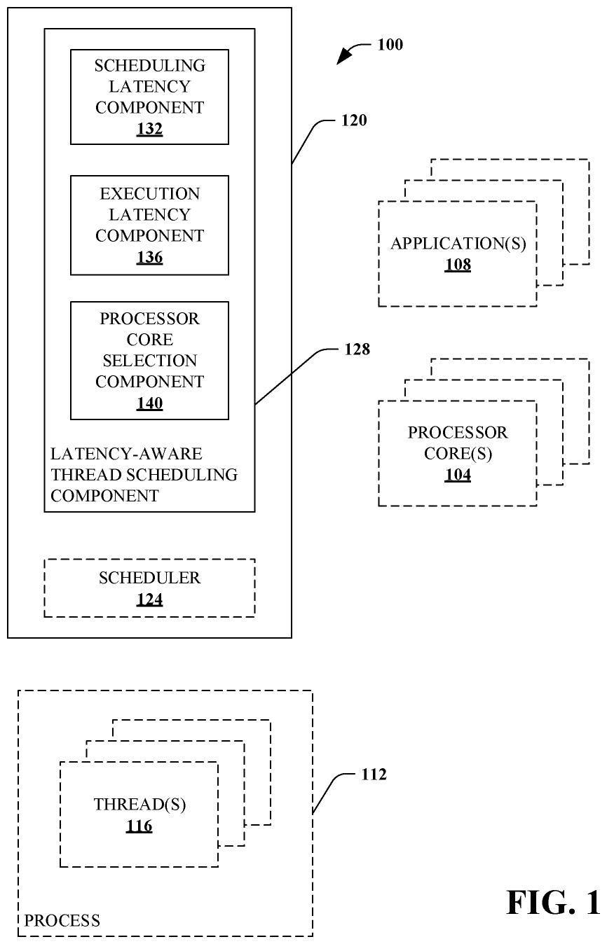

Referring to FIG. 1, a system for latency-aware thread scheduling 100 is illustrated. The system 100 includes a plurality of processor cores 104, and, one or more applications 108. The processor cores 104 can be included as part of a single processor (e.g., a multi-core processor) chip and/or as part of separate processor chips. In some embodiments, the processor cores 104 are a set of homogeneous processor cores 104. A set of homogeneous processor cores have the same physical characteristics, such as the same architecture, the same performance frequency range, the same power efficiency index, and so forth. Alternatively, the processor cores 104 may include processor cores having different physical characteristics.

The applications 108 can be any of a variety of different types of applications, such as productivity applications, gaming or recreational applications, utility applications, and so forth.

The applications 108 are executed as one or more processes 112 on the computing device 100. Each process 112 is an instantiation of an application 108. Each process 112 typically includes one or more threads 116. However, in some situations a process 112 does not include multiple threads 116, in which case the process can be treated as a single thread process.

Execution of the applications 108 is managed by scheduling execution of the threads 116 of the applications 108 by an operating system 120. Scheduling a thread for execution refers to informing a processor core 104 to execute the instructions of the thread. The operating system 120 includes a scheduler 124 that determines which threads 116 to schedule at which times for execution by which processor cores 104 based, at least in part, upon information provided by a latency-aware thread scheduling component 128.

Given a particular thread 116 to be executed, the latency-aware thread scheduling component 128 can select a particular processor core 104 on which to execute the particular thread 116. In some embodiments, if the thread 116 is performance-critical, the latency-aware thread scheduling component 128 can choose a processor core 104 that minimizes the length of time that will elapse before the work of the particular 116 is complete.

In some embodiments, this length of time can have two phases, one phase where the particular thread 116 is not executing yet (but the system is preparing to execute the particular thread 116) and one phase where the thread 116 is actually completing its work. The latency-aware thread scheduling component 128 explicitly considers the estimated lengths of both of these phases when deciding where to schedule thread(s) 116 (e.g., which processor core 104).

The latency-aware thread scheduling component 128 includes a scheduling latency calculation component 132, an execution latency calculation component 136, and a processor core selection component 140. The scheduling latency calculation component 132 can calculate an estimated cost (e.g., associated latency) to schedule the particular thread for each of a plurality of processor cores 104.

For purposes of explanation, and not limitation, for a system having eight processor cores 124, the scheduling latency calculation component 132 can calculate an estimated cost (e.g., associated latency) to schedule the particular thread for each of the eight processor cores 124.

In some embodiments, the estimated cost to schedule includes a period of time between the scheduling decision and the point in time where the scheduled thread begins to run. In some embodiments, the calculated estimated cost (e.g., associated latency) includes time spent bringing a particular target processor core 104 out of a low-power state (e.g., if the particular target processor core 124 is idle). In some embodiments, the calculated estimated cost (e.g., associated latency) includes time spent signaling the particular target processor 124 (e.g., via an inter-processor interrupt (IPI)) to get the particular target processor 104 to invoke the scheduler 124.

In some embodiments, the calculated estimated cost (e.g., associated latency) is based upon an estimate of time spent waiting for higher-priority thread(s) on a ready queue of the target processor 104 to execute. In some embodiments, the estimate of time spent waiting for higher-priority thread(s) on a ready queue of the target processor 104 to execute can be based upon a count of higher-priority threads, with each thread having a pre-defined associated estimated cost. In some embodiments, the pre-defined associated estimated cost can be dynamically adjusted based upon real-time feedback of thread execution times.

In some embodiments, the calculated estimated cost (e.g., associated latency) includes time spent waiting for higher-priority thread(s) on a ready queue of the target processor 104 to execute can be based upon an expected execution duration level assigned to each thread in the queue (e.g., “short” or “long”) with each level having an associated estimated cost (e.g., associated latency). The associated estimated cost of each higher-priority thread can be summed in order to calculate the total estimated cost of time spent waiting for higher-priority thread(s) on the ready queue of the target processor 104 to execute.

Additionally, the execution latency component 136 can calculate an estimated cost to execute the particular thread on each of the plurality of processor cores 104. In some embodiments, the estimated cost to execute includes a period of time spent actually running the particular thread on a particular processor core 104.

In some embodiments, the calculated estimated cost (e.g., associated latency) to execute the particular thread includes predicted costs (e.g., estimated cost) of memory access on the target processor 104 which can depend on the data the particular thread is accessing, whether the data is already resident in the cache of the processor core 104, and/or the cost to access physical memory if the data is not cached, and the like. For example, likelihood that data utilized by the particular thread will be available in a shared memory cache accessible by particular processor cores 104 can reduce predicted costs of memory access for those particular process cores 104 as compared to other processor core(s) 104. In this manner, the execution latency component 136 can take into consideration on which processor core(s) 104 the particular thread has been previously/recently executed.

In some embodiments, the calculated estimated cost (e.g., associated latency) to execute the particular thread includes current performance characteristic(s) of the target processor core 104 (e.g., heterogeneous class, current operating frequency, etc.). In some embodiments, the calculated estimated cost (e.g., associated latency) to execute the particular thread includes information regarding whether the target processor core 104 is sharing execution resource(s) with work on a sibling logical processor core 104. In some embodiments, the calculated estimated cost (e.g., associated latency) to execute the particular thread is based, at least in part, upon an observed latency of the particular thread on specific processor(s) which can be used to calculate the estimated cost (e.g., associated latency) on those specific processor(s).

In some embodiments, the calculated estimated cost (e.g., associated latency) to execute the particular thread is based, at least in part, upon compatibility of the target processor core 124 compatibility with a workload of the particular thread to be executed on the target processor core 104 using one or more tracked features of at least some of the processor cores 104 (e.g., a particular processor core 104 can have especially good capacity for running floating-point computations and/or branch-heavy workload(s)). In some embodiments, compatibility with the workload can be based, at least in part, upon, information generated ahead of time (e.g., prior to by calculation by the scheduling latency component 132) by profiler(s), binary analysis, historical data, etc. For purposes of explanation and not limitation, tracked features of heterogeneous processor cores 104 can include use of floating point operation(s), use of branch-heavy operation(s), use of particular instruction extension(s), an application programming interface (API) for thread(s) to self-declare a list of preferred and/or required instruction extension(s) to a base instruction set architecture (ISA), an API for thread(s) to indicate library(ies) used for the workload of the particular thread, which correlate the libraries to preferred and/or required instruction extension(s).

The processor core selection component 140 can determine (e.g., select) which processor core of the plurality of processor cores to utilize for execution of the particular thread based, at least in part, upon the calculated estimated costs to schedule the particular thread and/or the calculated estimated costs to execute the particular thread. For example, by estimating these costs for each particular <thread, processor core> tuple, the latency-aware thread scheduling component 128 can dynamically select a processor core 104 for a particular and so finish work faster.

In some embodiments, the operating system 120 can also use the estimated costs for each tuple to trade off power and/or performance. For example, if some work has a deadline of X, the operating system 120 can choose to run the work on the most power-efficient processor core 104 that still has an acceptable probability of completing the work in the specified amount of time.

In some embodiments, a specific thread 116 can be instrumented to provide and/or store metric(s) regarding performance characteristic(s) of one or more processor cores 104. The metric(s) can be utilized by the latency-aware thread scheduling component 128 in determining which processor core 104 of a plurality of processor cores 104 to utilize for execution of a particular thread 116.

In some embodiments, the latency-aware thread scheduling component 128 can obtain feedback information from one or more processor cores 104 regarding actual scheduling and/or actual execution of a particular thread 114 on particular processor core(s) 104. The latency-aware thread scheduling component 128 can utilize the feedback information to update calculation of estimated cost to schedule and/or calculation of estimated cost to execute.

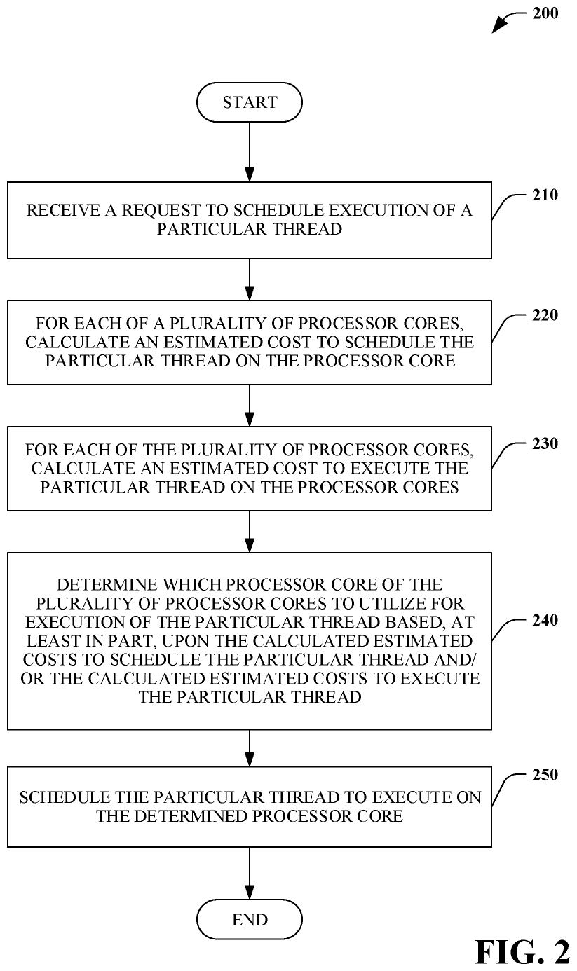

FIGS. 2-4 illustrate exemplary methodologies relating to latency-aware thread scheduling. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, a method of latency-aware thread scheduling 200 is illustrated. In some embodiments, the method 200 is performed by the system 100.

At 210, a request to schedule execution of a particular thread is received. At 220, for each of a plurality of processor cores, an estimated cost to schedule the particular thread for the processor core is calculated (e.g., dynamically). At 230, for each of the plurality of processor cores, an estimated cost to execute the particular thread on the processor core is calculated (e.g., dynamically).

At 240, a determination is made as to which processor core of the plurality of processor cores to utilize for execution of the particular thread based, at least in part, upon the calculated estimated costs to schedule the particular thread and/or the calculated estimated costs to execute the particular thread. At 250, the particular thread is scheduled to execute on the determined processor core.

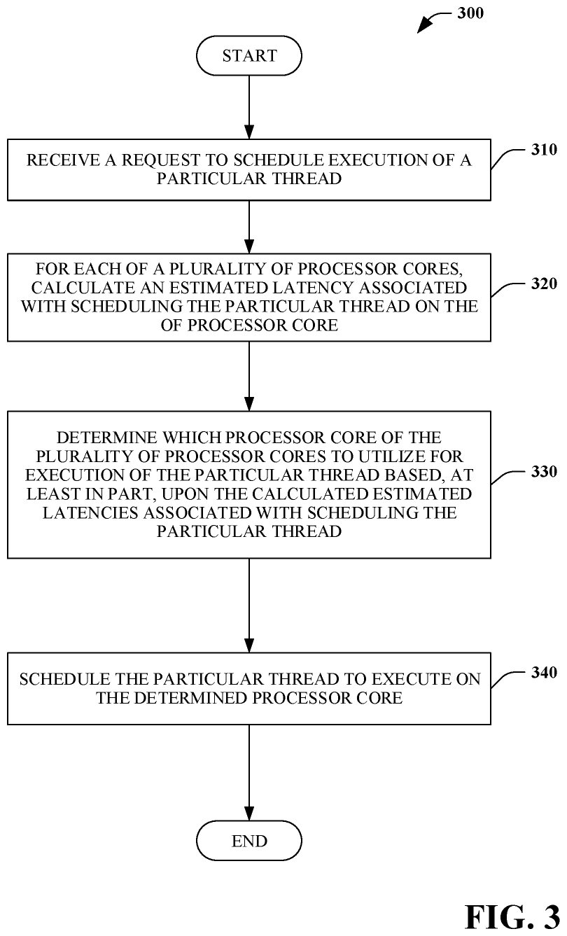

Turning to FIG. 3, a method of using latency associated with scheduling to schedule a thread 300. In some embodiments, the method 300 is performed by the system 100.

At 310, a request to schedule execution of a particular thread is received. At 320, for each of a plurality of processor cores, an estimated latency associated with scheduling the particular thread on the processor core is calculated (e.g., an estimated latency is calculated for each <thread, processor core> tuple).

At 330, a determination is made as to which processor core of the plurality of processor cores to utilize for execution of the particular thread based, at least in part, upon the calculated estimated latencies associated with scheduling the particular thread. At 340, the particular thread is scheduled to execute on the determined processor core.

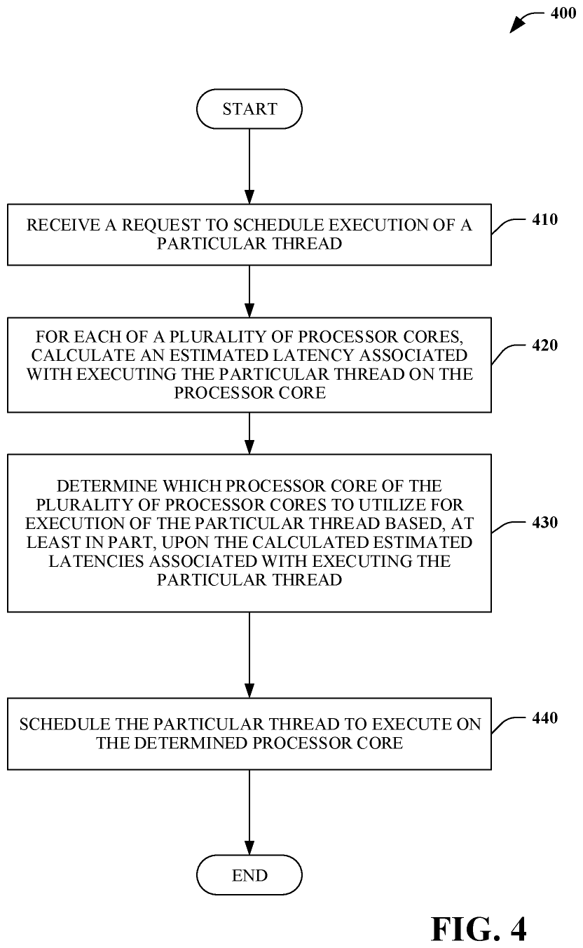

Next, referring to FIG. 4, a method of using latency associated with executing to schedule a thread 400. In some embodiments, the method 400 is performed by the system 100.

At 410, a request to schedule execution of a particular thread is received. At 420, for each of a plurality of processor cores, an estimated latency associated with executing the particular thread on the processor core is calculated (e.g., an estimated latency for each <thread, processor core> tuple).

At 430, a determination is made as to which processor core of the plurality of processor cores to utilize for execution of the particular thread based, at least in part, upon the calculated estimated latencies associated with executing the particular thread. At 440, the particular thread is scheduled to execute on the determined processor core.

Described herein is a system for latency-aware thread scheduling, comprising: a computer comprising a processor and a memory having computer-executable instructions stored thereupon which, when executed by the processor, cause the computer to: receive a request to schedule execution of a particular thread; for each of a plurality of processor cores, calculate an estimated cost to schedule the particular thread on the processor core; for each of the plurality of processor cores, calculate an estimated cost to execute the particular thread on the processor core; determine which processor core of the plurality of processor cores to utilize for execution of the particular thread based, at least in part, upon the calculated estimated costs to schedule the particular thread and the calculated estimated costs to execute the particular thread; and schedule the particular thread to execute on the determined processor core.

The system can further include wherein the estimated cost to schedule the particular thread comprises an estimated time to be spent to bring a particular processor core out of a low-power state. The system can further include wherein the estimated cost to schedule the particular thread comprises an estimated time to be spent to signal a particular processor core to have the particular processor core invoke a scheduler. The system can further include wherein the estimated cost to schedule the particular thread comprises an estimated time to be spent waiting for one or more higher-priority threads on a ready queue of a particular processor to execute.

The system can further include wherein the estimated cost to execute the particular thread comprises an estimated cost of memory accesses on a particular processor core for the particular thread. The system can further include wherein the estimated cost to execute the particular thread comprises a current performance characteristic of a particular processor core. The system can further include wherein the estimated cost to execute the particular thread is based, at least in part upon, at least one of compatibility of a particular processor core with a workload of the particular thread, or feedback information obtained from one or more particular processor cores regarding at least one of actual scheduling or actual execution of the particular thread on the one or more particular processor cores. The system can further include wherein the estimated cost to execute the particular thread comprises whether a particular processor core is sharing an execution resource with work on a sibling logical processor core.

Described herein is a method of latency-aware thread scheduling, comprising: receiving a request to schedule execution of a particular thread; for each of a plurality of processor cores, calculating an estimated cost to schedule the particular thread on the processor core; for each of the plurality of processor cores, calculating an estimated cost to execute the particular thread on the processor core; determining which processor core of the plurality of processor cores to utilize for execution of the particular thread based, at least in part, upon the calculated estimated costs to schedule the particular thread and the calculated estimated costs to execute the particular thread; and scheduling the particular thread to execute on the determined processor core.

The method can further include wherein the estimated cost to schedule the particular thread comprises an estimated time to be spent to bring a particular processor core out of a low-power state. The method can further include wherein the estimated cost to schedule the particular thread comprises an estimated time to be spent to signal the particular processor core to have the particular processor core invoke a scheduler. The method can further include wherein the estimated cost to schedule the particular thread comprises an estimated time to be spent waiting for one or more higher-priority threads on a ready queue of the particular processor to execute.

The method can further include wherein the estimated cost to execute the particular thread comprises an estimated cost of memory accesses on a particular processor core for the particular thread. The method can further include wherein the estimated cost to execute the particular thread comprises a current performance characteristic of a particular processor core. The method can further include wherein the estimated cost to execute the particular thread is based, at least in part upon at least one of compatibility of a particular processor core with a workload of the particular thread, or feedback information obtained from one or more particular processor cores regarding at least one of actual scheduling or actual execution of the particular thread on the one or more particular processor cores. The method can further include wherein the estimated cost to execute the particular thread comprises whether a particular processor core is sharing an execution resource with work on a sibling logical processor core.

Described herein is a computer storage medium storing computer-readable instructions that when executed cause a computing device to: receive a request to schedule execution of a particular thread; for each of a plurality of processor cores, calculate an estimated cost to schedule the particular thread on the processor core; for each of the plurality of processor cores, calculate an estimated cost to execute the particular thread on the processor core; determine which processor core of the plurality of processor cores to utilize for execution of the particular thread based, at least in part, upon the calculated estimated costs to schedule the particular thread and the calculated estimated costs to execute the particular thread; and schedule the particular thread to execute on the determined processor core.

The computer storage medium can further include wherein the estimated cost to schedule the particular thread comprises at least one of an estimated time to be spent to bring a particular processor core out of a low-power state, an estimated time to be spent to signal the particular processor core to have the particular processor core invoke a scheduler, or an estimated time to be spent waiting for one or more higher-priority threads on a ready queue of the particular processor core to execute. The computer storage medium can further include wherein the estimated cost to execute the particular thread comprises at least one of an estimated cost of memory accesses on a particular processor core for the particular thread, or a current performance characteristic of the particular processor core, or is based, at least in part, upon compatibility of the particular processor core with a workload of the particular thread. The computer storage medium can further include wherein the estimated cost to execute the particular thread comprises whether a particular processor core is sharing an execution resource with work on a sibling logical processor core.

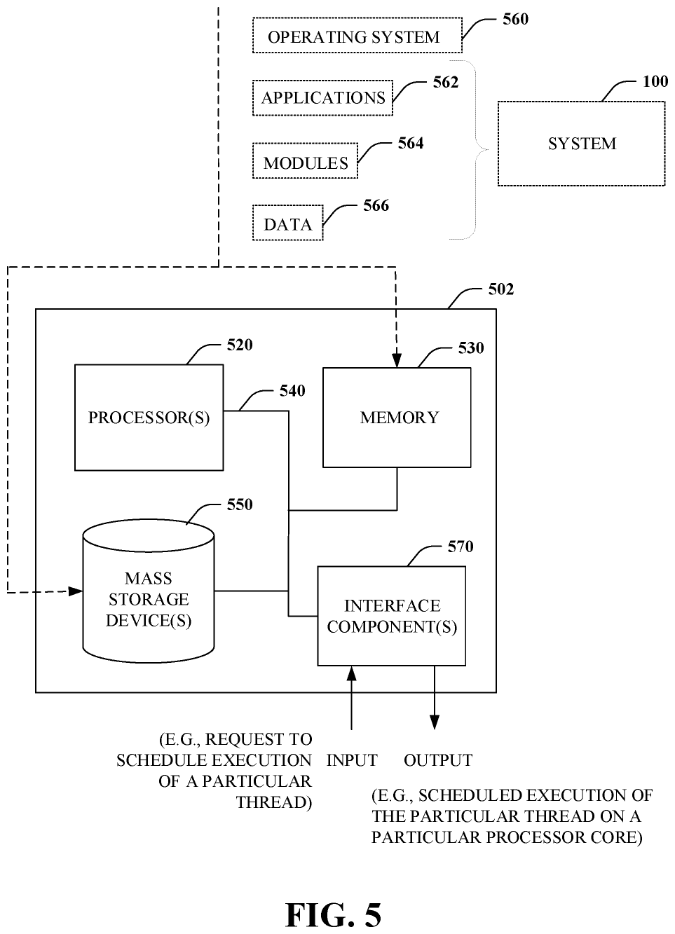

With reference to FIG. 5, illustrated is an example general-purpose computer or computing device 502 (e.g., mobile phone, desktop, laptop, tablet, watch, server, hand-held, programmable consumer or industrial electronics, set-top box, game system, compute node, etc.). For instance, the computing device 502 may be used in a system 100.

The computer 502 includes one or more processor(s) 520, memory 530, system bus 540, mass storage device(s) 550, and one or more interface components 570. The system bus 540 communicatively couples at least the above system constituents. However, it is to be appreciated that in its simplest form the computer 502 can include one or more processors 520 coupled to memory 530 that execute various computer executable actions, instructions, and or components stored in memory 530. The instructions may be, for instance, instructions for implementing functionality described as being carried out by one or more components discussed above or instructions for implementing one or more of the methods described above.

The processor(s) 520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 520 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 520 can be a graphics processor.

The computer 502 can include or otherwise interact with a variety of computer-readable media to facilitate control of the computer 502 to implement one or more aspects of the claimed subject matter. The computer-readable media can be any available media that can be accessed by the computer 502 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 502. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 530 and mass storage device(s) 550 are examples of computer-readable storage media. Depending on the exact configuration and type of computing device, memory 530 may be volatile (e.g., RAM), non-volatile (e.g., ROM, flash memory, etc.) or some combination of the two. By way of example, the basic input/output system (BIOS), including basic routines to transfer information between elements within the computer 502, such as during start-up, can be stored in nonvolatile memory, while volatile memory can act as external cache memory to facilitate processing by the processor(s) 520, among other things.

Mass storage device(s) 550 includes removable/non-removable, volatile/non-volatile computer storage media for storage of large amounts of data relative to the memory 530. For example, mass storage device(s) 550 includes, but is not limited to, one or more devices such as a magnetic or optical disk drive, floppy disk drive, flash memory, solid-state drive, or memory stick.

Memory 530 and mass storage device(s) 550 can include, or have stored therein, operating system 560, one or more applications 562, one or more program modules 564, and data 566. The operating system 560 acts to control and allocate resources of the computer 502. Applications 562 include one or both of system and application software and can exploit management of resources by the operating system 560 through program modules 564 and data 566 stored in memory 530 and/or mass storage device (s) 550 to perform one or more actions. Accordingly, applications 562 can turn a general-purpose computer 502 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 562, and include one or more modules 564 and data 566 stored in memory and/or mass storage device(s) 550 whose functionality can be realized when executed by one or more processor(s) 520.

In some embodiments, the processor(s) 520 can correspond to a system on a chip (SOC) or like architecture including, or in other words integrating, both hardware and software on a single integrated circuit substrate. Here, the processor(s) 520 can include one or more processors as well as memory at least similar to processor(s) 520 and memory 530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 502 also includes one or more interface components 570 that are communicatively coupled to the system bus 540 and facilitate interaction with the computer 502. By way of example, the interface component 570 can be a port (e.g. serial, parallel, PCMCIA, USB, FireWire, etc.) or an interface card (e.g., sound, video, etc.) or the like. In one example implementation, the interface component 570 can be embodied as a user input/output interface to enable a user to enter commands and information into the computer 502, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 570 can be embodied as an output peripheral interface to supply output to displays (e.g., LCD, LED, plasma, etc.), speakers, printers, and/or other computers, among other things. Still further yet, the interface component 570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for latency-aware thread scheduling, comprising:
a computer comprising a processor and a memory having computer-executable instructions stored thereupon which, when executed by the processor, cause the computer to:
receive a request to schedule execution of a particular thread;
for each of a plurality of processor cores, calculate an estimated cost to schedule the particular thread on the processor core;
for each of the plurality of processor cores, calculate an estimated cost to execute the particular thread on the processor core;
determine which processor core of the plurality of processor cores to utilize for execution of the particular thread based, at least in part, upon the calculated estimated costs to schedule the particular thread and the calculated estimated costs to execute the particular thread; and
schedule the particular thread to execute on the determined processor core.

2. The system of claim 1, wherein the estimated cost to schedule the particular thread comprises an estimated time to be spent to bring a particular processor core out of a low-power state.

3. The system of claim 1, wherein the estimated cost to schedule the particular thread comprises an estimated time to be spent to signal a particular processor core to have the particular processor core invoke a scheduler.

4. The system of claim 1, wherein the estimated cost to schedule the particular thread comprises an estimated time to be spent waiting for one or more higher-priority threads on a ready queue of a particular processor to execute.

5. The system of claim 1, wherein the estimated cost to execute the particular thread comprises an estimated cost of memory accesses on a particular processor core for the particular thread.

6. The system of claim 1, wherein the estimated cost to execute the particular thread comprises a current performance characteristic of a particular processor core.

7. The system of claim 1, wherein the estimated cost to execute the particular thread is based, at least in part upon, at least one of compatibility of a particular processor core with a workload of the particular thread, or feedback information obtained from one or more particular processor cores regarding at least one of actual scheduling or actual execution of the particular thread on the one or more particular processor cores.

8. The system of claim 1, wherein the estimated cost to execute the particular thread comprises whether a particular processor core is sharing an execution resource with work on a sibling logical processor core.

9. A method of latency-aware thread scheduling, comprising:
receiving a request to schedule execution of a particular thread;
for each of a plurality of processor cores, calculating an estimated cost to schedule the particular thread on the processor core;
for each of the plurality of processor cores, calculating an estimated cost to execute the particular thread on the processor core;
determining which processor core of the plurality of processor cores to utilize for execution of the particular thread based, at least in part, upon the calculated estimated costs to schedule the particular thread and the calculated estimated costs to execute the particular thread; and
scheduling the particular thread to execute on the determined processor core.

10. The method of claim 9, wherein the estimated cost to schedule the particular thread comprises an estimated time to be spent to bring a particular processor core out of a low-power state.

11. The method of claim 9, wherein the estimated cost to schedule the particular thread comprises an estimated time to be spent to signal the particular processor core to have the particular processor core invoke a scheduler.

12. The method of claim 9, wherein the estimated cost to schedule the particular thread comprises an estimated time to be spent waiting for one or more higher-priority threads on a ready queue of the particular processor to execute.

13. The method of claim 9, wherein the estimated cost to execute the particular thread comprises an estimated cost of memory accesses on a particular processor core for the particular thread.

14. The method of claim 9, wherein the estimated cost to execute the particular thread comprises a current performance characteristic of a particular processor core.

15. The method of claim 9, wherein the estimated cost to execute the particular thread is based, at least in part upon at least one of compatibility of a particular processor core with a workload of the particular thread, or feedback information obtained from one or more particular processor cores regarding at least one of actual scheduling or actual execution of the particular thread on the one or more particular processor cores.

16. The method of claim 9, wherein the estimated cost to execute the particular thread comprises whether a particular processor core is sharing an execution resource with work on a sibling logical processor core.

17. A computer storage medium storing computer-readable instructions that when executed cause a computing device to:
receive a request to schedule execution of a particular thread;
for each of a plurality of processor cores, calculate an estimated cost to schedule the particular thread on the processor core;
for each of the plurality of processor cores, calculate an estimated cost to execute the particular thread on the processor core;
determine which processor core of the plurality of processor cores to utilize for execution of the particular thread based, at least in part, upon the calculated estimated costs to schedule the particular thread and the calculated estimated costs to execute the particular thread; and
schedule the particular thread to execute on the determined processor core.

18. The computer storage medium of claim 17, wherein the estimated cost to schedule the particular thread comprises at least one of an estimated time to be spent to bring a particular processor core out of a low-power state, an estimated time to be spent to signal the particular processor core to have the particular processor core invoke a scheduler, or an estimated time to be spent waiting for one or more higher-priority threads on a ready queue of the particular processor core to execute.

19. The computer storage medium of claim 17, wherein the estimated cost to execute the particular thread comprises at least one of an estimated cost of memory accesses on a particular processor core for the particular thread, or a current performance characteristic of the particular processor core, or is based, at least in part, upon compatibility of the particular processor core with a workload of the particular thread.

20. The computer storage medium of claim 17, wherein the estimated cost to execute the particular thread comprises whether a particular processor core is sharing an execution resource with work on a sibling logical processor core.
